(19) United States
(12) Patent Application Publication
(10) Pub. No.: US 2012/0280485 A1
(43) Pub. Date: Nov. 8, 2012

(54) SOLID STATE BASED JOINING PROCESSES WITH POST-WELD PROCESSING(S) UNDER COMPRESSION AND APPARATUSES THEREFOR

(76) Inventors: Israel Stol, Pittsburgh, PA (US); Stephen Makosey, Export, PA (US); John Cobes, Lower Burrell, PA (US); Daniel Bergstrom, Sarver, PA (US)

(21) Appl. No.: 13/463,588

(22) Filed: May 3, 2012

Related U.S. Application Data
(60) Provisional application No. 61/481,731, filed on May 3, 2011.
(60) Provisional application No. 61/523,314, filed on Aug. 13, 2011.

(51) Int. Cl. C21D 9/50; F16L 47/02; C22F 1/08; C22F 1/00; C22F 1/04

(52) U.S. Cl. 285/21.1; 148/527; 148/535; 148/529; 148/530; 148/532; 148/533; 148/536

(57) ABSTRACT

Methods for welding a first metal part to a second metal part by a solid state process to form a welded article having at least a welded region are provided herein. The welded region of the weld is post-weld aged by heating it to a set temperature for a set time and compressing the weld.

### CROSS-REFERENCE TO RELATED APPLICATIONS

This patent application claims the priority and benefit of prior U.S. Patent Application Nos. 61/481,731 filed on May 3, 2011 and 61/523,314 filed on Aug. 13, 2011.

### FIELD OF THE DISCLOSURE

This disclosure relates generally to solid-state welding processes and apparatuses therefor. More particularly, this disclosure relates to solid-state welding processes, which include subjecting the weld to post-weld heat and compression.

### BACKGROUND OF THE DISCLOSURE

Solid-state based joining processes for welding two or more components to each other are generally known, and may include without limitation friction welding, friction stir welding, diffusion bonding, cold welding, and explosion welding. Also generally known are methods for improving the weld such as by subjecting the weld to heat for a period of time post-weld. Such methods have been used for joining hollow metal articles, including pipes.

### SUMMARY PARAGRAPHS

In accordance with an aspect of an illustrating embodiment of the present disclosure, a method is provided. The method includes welding at least a first end of a first metal part to a second end of a second metal part by a solid state process to form an article having a weld having a weld region. The method further includes post-weld aging at least the weld region by heating at least the weld to a temperature for a time and compressing the weld.

Those skilled in the art will further appreciate the above-mentioned advantages and superior features of the disclosure together with other important aspects thereof upon reading the detailed description which follows in conjunction with the drawing figures.

### BRIEF DESCRIPTION OF THE DRAWING FIGURES

The present disclosure will be further explained with reference to the attached drawing figures, wherein like structures/elements are referred to by like numerals throughout the several views, alphabetized structures/elements indicate multiples of the various structures/elements, and primed numbering is given to mirrored structures/elements. The drawing figures shown are not necessarily to scale, with emphasis instead generally being placed upon illustrating the principles of the present disclosure.

FIG. 1A is an illustrative first step of an embodiment of a known welding method for the joining two metal parts;

FIG. 1B is an illustrative second step of an embodiment of a known welding method for the joining two metal parts;

FIG. 1C is an illustrative third step of an embodiment of a known welding method for the joining two metal parts;

FIG. 1D is an illustrative fourth step of an embodiment of a known welding method for the joining two metal parts;

FIG. 2 is a cross-section view of an article welded in accordance with the steps of FIGS. 1A-D;

FIG. 3A is a macrograph of the cross-sectional section the welded article of FIG. 2;

FIG. 3B is a micrograph taken at a 200 micron scale magnification of a portion of the macrograph of FIG. 3A;

FIG. 3C is a micrograph taken at a 50 micron scale magnification of a portion of the macrograph of FIG. 3A;

FIG. 3D is a micrograph taken at a 200 micron scale magnification of a portion of the macrograph of FIG. 3A;

FIG. 3E is a micrograph taken at a 200 micron scale magnification of a portion of the macrograph of FIG. 3A;

FIG. 3F is a micrograph taken at a 200 micron scale magnification of a portion of the macrograph of FIG. 3A;

FIG. 3G is a micrograph taken at a 200 micron scale magnification of a portion of the macrograph of FIG. 3A;

FIG. 3H is a micrograph taken at a 50 micron scale magnification of a portion of the macrograph of FIG. 3A;

FIG. 3I a micrograph taken at a 200 micron scale magnification of a portion of the macrograph of FIG. 3A;

FIG. 4A is a side-cross-sectional view of an embodiment of an apparatus for applying a compressive load to a weld of a friction welded assembly;

FIG. 4B is a side-cross-sectional view of an embodiment of a second apparatus for applying a compressive load to a weld of an alternative friction welded assembly;

FIG. 5 is a perspective view of an embodiment of a second friction welded assembly having thrust/torque transmitting grooves;

FIG. 6 is an illustrative cross-section view of an embodiment of a compression clamp engaged with two grooves of a third friction welded assembly;

FIG. 7 is a perspective view of a photograph of a friction welded assembly such as the friction welded assembly of FIG. 4A engaged in an apparatus such as the apparatus of FIG. 4A for applying a compressive load to a weld of the friction welded assembly;

FIG. 8 is a second perspective view of a picture of a friction welded assembly such as the friction welded assembly of FIG. 4A engaged in an apparatus such as the apparatus of FIG. 4A for applying a compressive load to a weld of the friction welded assembly;

FIG. 9 is an illustrative exploded, perspective view of a clamping installation system;

FIG. 10 is an illustrative perspective view of a first step of a clamping installation system of FIG. 9;

FIG. 11 is an illustrative perspective view of a second step of a clamping installation system of FIG. 9;

FIG. 12 is an illustrative perspective view of a third step of a clamping installation system of FIG. 9;

FIGS. 13A and 13B are illustrative perspective views of a fourth step of a clamping installation system of FIG. 9;

FIG. 14 is an illustrative perspective view of a fifth step of a clamping installation system of FIG. 9;

FIG. 15 is an illustrative perspective view of a sixth through eighth step of a clamping installation system of FIG. 9;

FIG. 16 is an illustrative perspective view of a ninth and tenth step of a clamping installation system of FIG. 9;

FIGS. 17A and 17B are illustrative perspective views of an optional locking ring of a clamping installation system of FIG. 9;

FIG. 18 is an illustrative perspective view of a third apparatus for providing a compressive force or stress to a post weld aged large tubular structure having a friction weld;

FIG. 19 is an illustrative perspective view of a fourth apparatus for providing a compressive force or stress to a post weld aged large tubular structure having a diffusive weld; and

FIGS. 20A-20F are perspective views of a fifth apparatus for providing a compressive force or stress to a welded assembly having a friction stir weld.

### DETAILED DESCRIPTION OF THE DISCLOSURE

Detailed embodiments of the present disclosure are disclosed herein; however, it is to be understood that the disclosed embodiments are merely illustrative of the disclosure that may be embodied in various forms. In addition, each of the examples given in connection with the various embodiments of the disclosure are intended to be illustrative, and not restrictive. Further, the drawing figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present disclosure.

In various embodiments herein, the term “comparative friction welded article,” may be intended to mean a friction welded article that is post-weld aged (for example by heating) without compressive stress.

In various embodiments herein, the term “compressive stress” may mean the compressive stress superimposed on various “friction welds” at least during a portion of a post-weld heat treating (e.g. aging) cycle. The compressive stress may be calculated prior to the application of a compressive stress, or measured during the application of the compressive stress by stain gages attached to the friction weld, the two welded parts, and/or the tension rods with which the compressive load may be applied.

In various embodiments herein, the term “creep” may mean the movement experienced by the “friction welds” and their adjoining regions, which may be induced by the combination of the post-weld heat treating (e.g. aging) cycle (i.e. temperature and time) and residual stresses “locked” into the “friction articles” and adjacent to the welds.

In various embodiments herein, the term “end plate” may mean one of the pair of thick plates through which tension bolts or rods may be placed and against which the tightening nuts may be tightened, in order to put the bolts or rods under tension and the friction welds under compression.

In various embodiments herein, the term “ID” may mean “internal diameter” or “inner diameter.”

In various embodiments herein, the term “OD” may mean “outside diameter” or “outer diameter.”

In various embodiments herein, the term “machined” may mean an operation used to: prepare extruded metallic parts for “friction welding” and/or post-weld machining of the welding flash on the ID and OD of the articles, as a way of removing the “post-weld ravines” formed at their bases.

In various embodiments herein, the term “post-weld ravine” may mean a sharp feature formed at the base either or both of the ID and OD weld flash upon “friction welding” two metal parts together.

In various embodiments herein, the term “post-weld aging” may mean the post-weld heat treating operation(s) during which some of the constituents in the friction welds and their adjoining regions (e.g. the heat affected zone (“HAZ”) and the thermo-mechanically stirred zone (“TMAZ”)) precipitate. Applicants presently believe that “post-weld aging” imparts beneficial mechanical and corrosion resistant properties to friction welds.

In various embodiments herein, the term “residual stress” may mean the stresses that were introduced and locked into the friction welds and their adjoining regions during the welding operation.

In various embodiments herein, the term “strain rate” may mean the rate at which material being loaded is being strained and deformed.

In various embodiments herein, the term “thrust-transmitting tongue” may mean a part of an apparatus which transmits thrust load, during the friction welding operation, from for example hydraulically or electromechanically driven pistons of a machine into the parts being friction welded, through engagement with the edges of the corresponding grooves on the parts.

In various embodiments herein, the term “article” may mean a structure subject to a welding process (e.g. a friction welding).

In various embodiments herein, the term “weld-flash” may mean the material that is expelled from the interface between the parts being friction welded, in the form of plasticized material during the welding operation; as soon as the plasticized material is expelled onto the ID and OD of the joint, it may cool down in the form of the flash.

In various embodiments herein, the term “weld region” may mean the friction weld and its adjacent regions that include the HAZ and the TMAZ.

In various embodiments herein, the term “yield strength” may mean the strength of a material at which the material begins to undergo permanent deformation, measured in such units as pounds per square inch (“psi”) or megapascals (“MPa”).

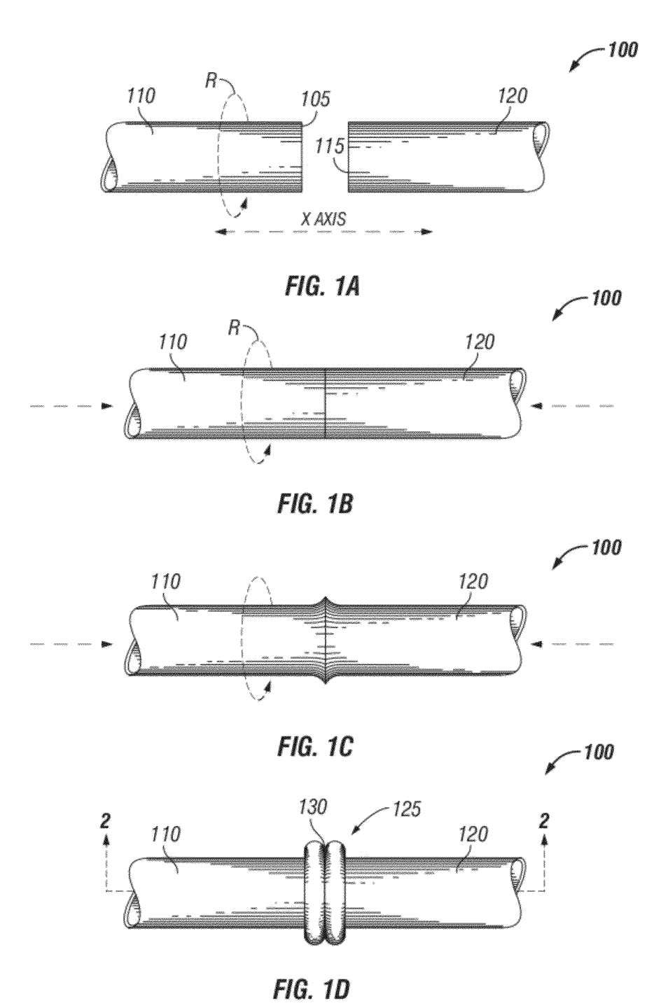

With reference to FIGS. 1A-1D, and without limitation, a friction welding process 100 is illustrated. The friction welding process 100 is an illustrative non-limiting example of a solid state process for welding at least a first end 105 of a first metal part 110 to a second end 115 of a second metal part 120 to form an article 125 having a weld 130. Without limitation, other suitable solid state processes may include, for example, friction stir welding, diffusion bonding, cold welding, and explosion welding.

With reference to FIG. 1 A, the first end 105 of the first metal part 110 may be placed in substantial alignment with and in opposition to the second end 115 of the second metal part 115. In an embodiment, the first metal part 110 may be rotated about its longitudinal axis, X, either in the direction indicated by the circular arrow, R, or in the opposite direction, as the first metal part 110 and the second metal part 120 are aligned. In an alternative example, the second metal part 120 may be rotated (in either direction) about its longitudinal axis, X, as the first metal part 110 and the second metal part 120 are aligned. In further alternative embodiments, neither or both the first metal part 110 and the second metal part 120 may be rotated as they are aligned with each other.

FIG. 1B illustrates that the first end 105 of the first metal part 110 and the second end 115 of the second metal part 120 may be placed against (or abutted against) each other and the first metal part 110 may be rotated (in either direction about the “X” axis) as the second metal part 120 remains fixed. Of course, the second metal part 120 may be rotated (in either direction about the “X” axis) as the first metal part 110 remains fixed, or both parts may be rotated (preferably in directions opposite each other). In an embodiment, illustrated with respect to FIG. 1C, the first rotation of the first metal part 110 (and/or the second metal part 120) is preferably sufficient enough for a molten zone 125 to start to form. In an embodiment, illustrated with respect to FIG. 1D, the first rotation of the first metal part 110 (and/or the second metal part 120) is preferably sufficient enough for a weld 130 between the parts to form. Alternatively, instead of being rotated the parts 105, 110 as illustrated in FIGS. 1A-1D may be independently linearly vibrated in any direction.

In an embodiment, the first metal part 110 may be an aluminum alloy selected from the group consisting of a 1xxx series through 8xxx series and in particular 5xxx series, 6xxx series, and 7xxx series aluminum alloys, titanium, titanium alloys, steel, stainless steel, copper, copper alloys, zinc, and zinc alloys (including without limitation 7085, 7075, 7055, 7050, 6013, and 5083 aluminum alloys). In an embodiment, the second metal part 120 may be a metal selected from the group consisting of a 1xxx series through 8xxx series and in particular 5xxx series, 6xxx series, and 7xxx series aluminum alloys, titanium, titanium alloys, steel, stainless steel, copper, copper alloys, zinc, and zinc alloys (including without limitation 7085, 7075, 7055, 7050, 6013, and 5083 aluminum alloys). The first metal part 110 may have the same or different composition as the second metal part 120. In still further embodiments, the first metal part 110 and the second metal part 120 may each have any shape, including without limitation a generally tubular shape. In embodiments wherein the first metal part 110 and the second metal part 120 have a generally tubular shape, the first metal part 110 and the second metal part 120 may each have an ID ranging, independently, from between about 1 inch and about 6 inches, and an OD ranging, independently, from between about 3 inches to about 10 inches. The ID and the OD of the first metal part 110 and the second metal part 120 may be, independently, approximately the same or different. Preferably, the ID and the OD of the first metal part 110 and the second metal part 120 are approximately the same.

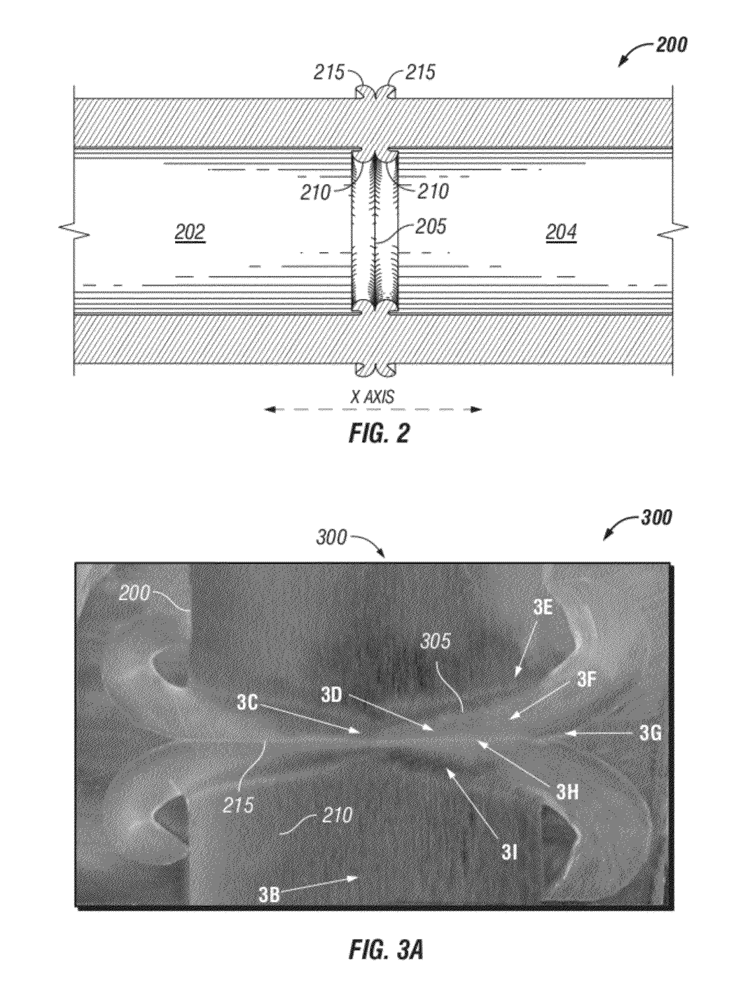

FIG. 2 illustrates a cross section, taken along the longitudinal axis, X, of a friction-welded article 200. The first part 202 and second part 204 were each a 7xxx-T6 aluminum alloy having an OD of 6 inches and an ID of 3 inches. The welded article 200 of FIG. 2 having a weld 205 was in the as-welded condition with an ID weld-flash 210 and an OD weld-flash 215 intact (i.e., not removed). Without wishing to be bound by the theory, Applicant believes that in prior methods cracks (not found in FIG. 2) starting at an inner diameter of the weld 205 may form during subsequent processing (such as optionally machining off the ID and OD weld-flash and post-weld aging the weld 205) as a result of residual stress distributions in the weld, and/or creep, which may occur in the adjoining heat affected zones during post-weld aging (described in detail below). Applicant further believes, without wishing to be bound by the theory, that in prior methods ravines—or surface defects (not found in FIG. 2) may form during subsequent processing (such as optionally machining off the ID and OD weld-flash and post-weld aging the weld 205) predominately at the bases of the inner weld-flash 210 and the outer weld-flash 215.

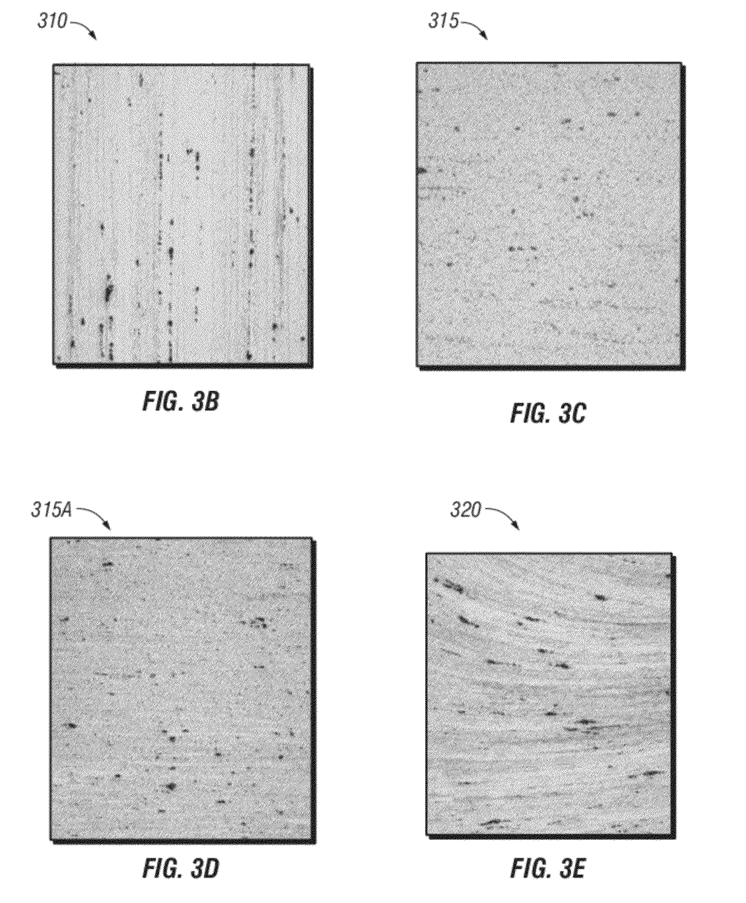

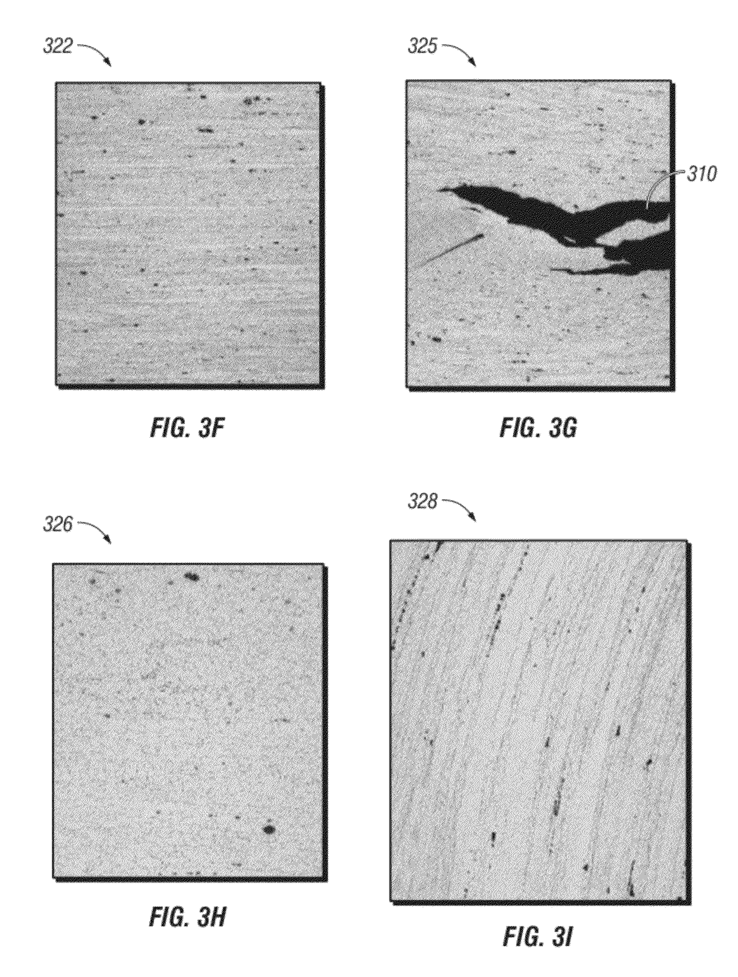

FIG. 3A illustrates a macrograph 300 (at 100 times magnification) of the welded article 200 of FIG. 2. FIG. 3B illustrates a micrograph of a portion of FIG. 3A taken at a 200 micron scale magnification of a portion of the base material 210 having a horizontal (with respect to longitudinal axis “X” of FIGS. 1 and 2) grain structure. FIG. 3C illustrates a micrograph of a portion of FIG. 3A taken at a 50 micron scale magnification of a portion of the weld 215 having a vertical grain structure. FIG. 3D illustrates a micrograph of a portion of FIG. 3A taken at a 200 micron scale magnification of a portion of the weld 215 having a vertical grain structure. FIG. 3E illustrates a micrograph of a portion of FIG. 3A taken at a 200 micron scale magnification of a portion of the TMAZ 305 of the weld region having a generally vertically-curved cross section structure, formed by being dragged under high sheer stresses, which may have occurred during the expulsion of plastized material during welding. FIG. 3F illustrates a micrograph of a portion of FIG. 3A taken at a 200 micron scale magnification of a portion of the weld 215 having a vertical grain structure. FIG. 3G illustrates a micrograph of a portion of FIG. 3A taken at a 200 micron scale magnification of a portion of a post-weld ravine 310 formed at the base of the weld flash 315. FIG. 3H illustrates a micrograph of a portion of FIG. 3A taken at a 50 micron scale magnification of a portion of the weld 215 having a vertical grain structure. FIG. 3I illustrates a micrograph of a portion of FIG. 3A taken at a 200 micron scale magnification of a portion of the weld 215 having a horizontally-cured grain structure.

In further accordance with the methods provided herein, the weld formed by the solid state process may be post-weld aged. In an embodiment, suitable post-weld aging processes (or methods) may include a process by which a welded metal article may be heated to a temperature and for a time sufficient to enhance the mechanical and/or corrosion resistant properties of the welded metal article beyond the mechanical and/or corrosion resistant properties of the welded metal article prior to post-weld aging. In still further embodiments, the welded metal article may be heated to a temperature and for a time sufficient for elements to precipitate. Without wishing to limit the disclosure, in an embodiment, the welded metal articles of the present disclosure, or at least the weld regions thereof, may be heated themselves (or the oven/heater may be set to) a temperature ranging from between about 100F to about 500F; alternatively between about 200F to about 350F, alternatively between about 300F and about 325F, and for a time ranging between about 1 hour to about 36 hours, alternatively between about 2 hours to about 24 hours, alternatively between about 6 hours and about 18 hours.

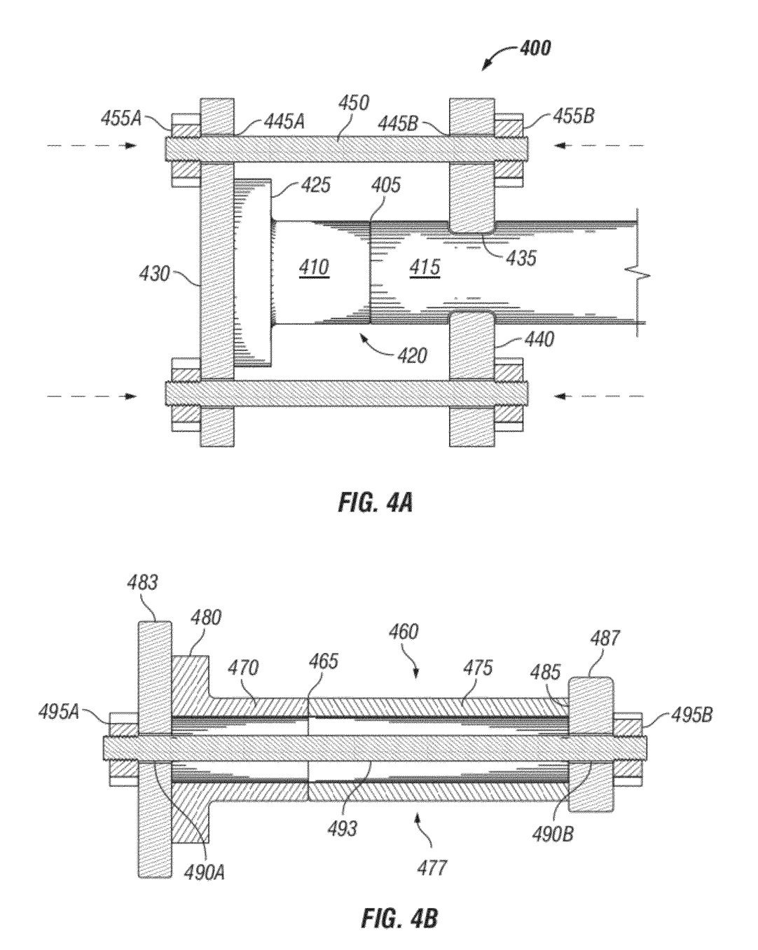

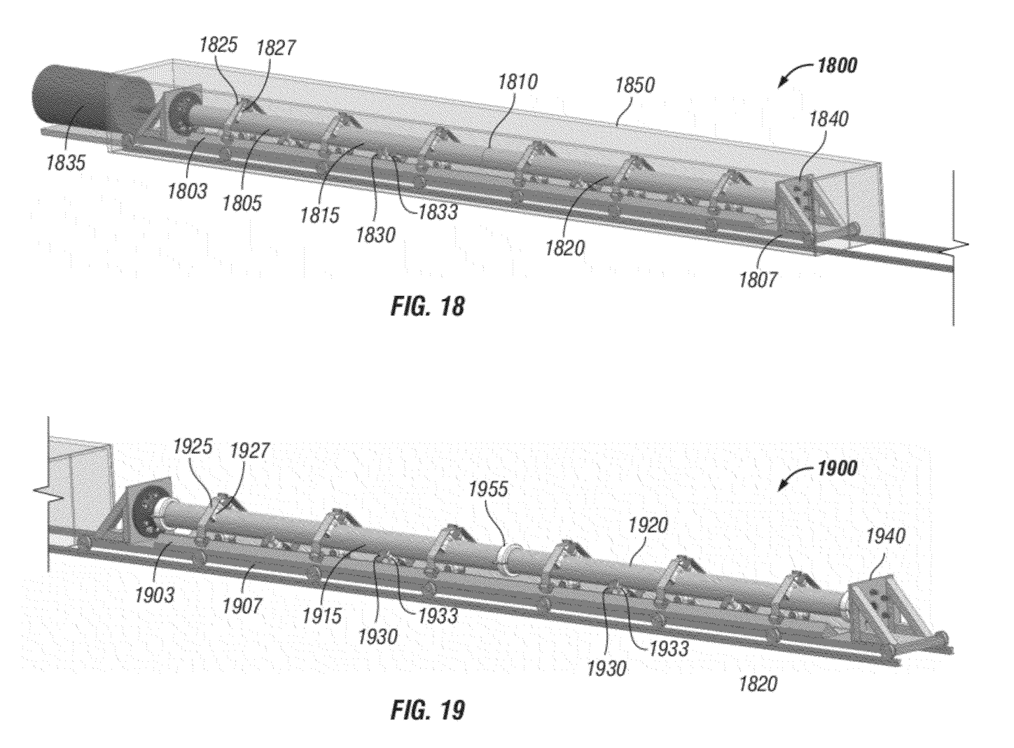

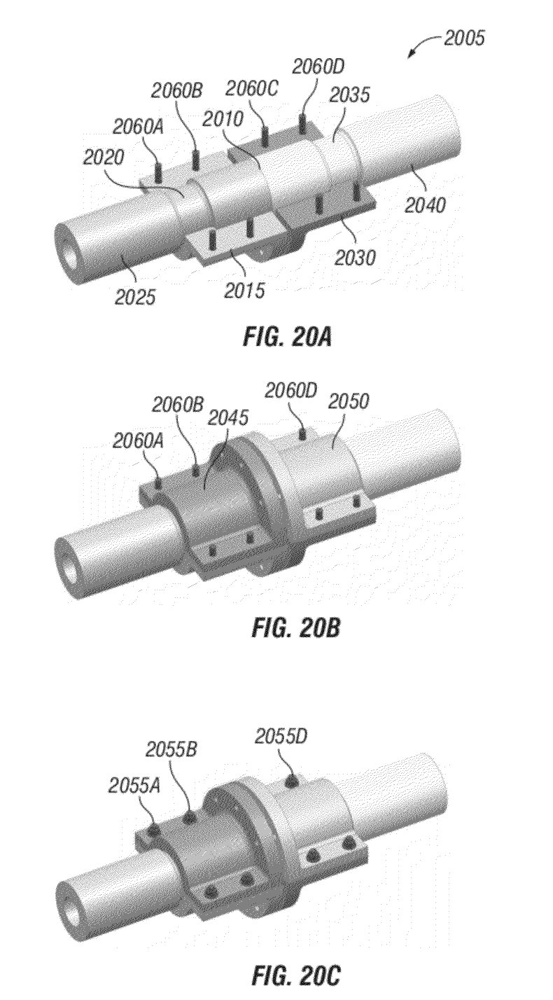

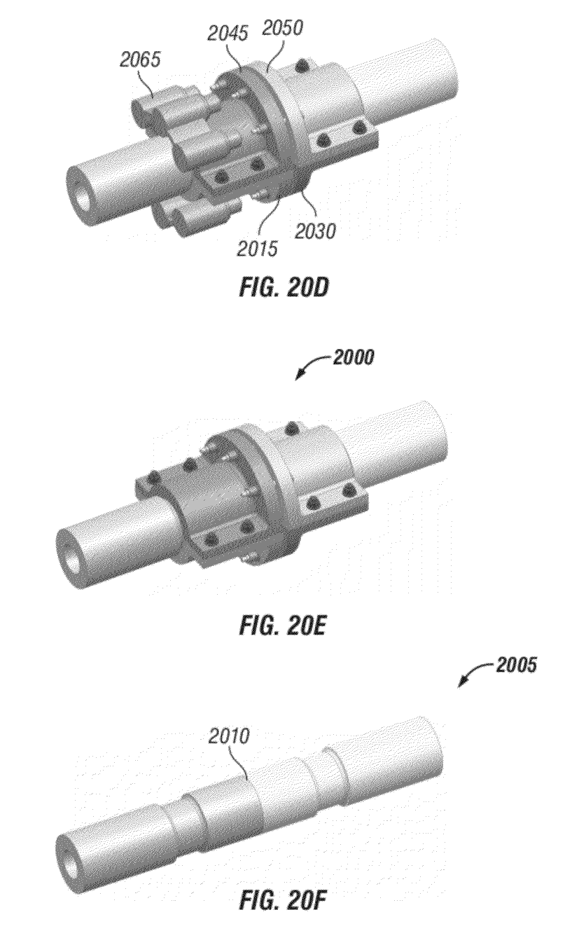

In further accordance with the methods provided herein, the weld, or weld region, formed by the solid state process may be compressed prior to and/or while it undergoes post-weld aging. In an embodiment, the weld, or weld region, may be compressed at least the enter time the weld undergoes post-weld aging. Alternatively, the weld, or weld region, may be compressed less than the enter time the weld, or weld region, undergoes post-weld aging. In an embodiment, the weld or weld region may be locally compressed (for example by using the compressive apparatuses of FIGS. 4A and 4B and FIGS. 20A-20F) or globally compressed (for example by using the compressive apparatuses of FIGS. 18 and 19) to a compressive stress at least about 10 ksi; alternatively at least about 20 ksi; alternatively at least about 30 ksi; alternatively between about 10 ksi and about 50 ksi; alternatively between about 20 ksi and about 45 ksi; alternatively between about 20 ksi and about 40 ksi; alternatively between about 30 ksi and about 45 ksi. In a still further embodiment, the weld and/or weld region may have an initial residual stress on its ID, and the weld and/or weld region may be compressed to a compressive stress sufficient to reduce the initial residual stress on the ID of the weld and/or weld region by at least about 5 ksi to a second residual stress. In yet a still further embodiment, the compressive stress applied to the weld and/or weld region may be equal to or greater than the yield strength of the weld region (i.e., the weld and the HAZ) between the welded metal parts. Applicants presently believe that the compressive based post-weld aging of the friction weld may counteract the creep of the friction weldment at the “weakened” regions of the weld during the post-weld cycle; reduce and/or counteract the high tension residual-stresses at the ID of the welds; minimize the potential for coalescence of dislocations in the welds by the combined effect of creep and tension type residual stress at the ID which may lead to the formation of microscopic voids in the welds, which may in turn act as stress risers for initiation and/or propagation of cracks in the welds; counteract the potentially detrimental effects of the friction weld's extremely fine microstructure on the formation of discontinuities during the post-weld aging cycle; counteract the potential effects of extremely small constitutes in the weld (e.g. segregated at grain boundaries and/or matrix) that could be multifaceted and/or sharp which could act as crack initiation sites; and held keep the weld consolidated and sound during the post-weld aging cycle and counteract the stress rising effects and potential propagation of surface discontinuity (e.g. ravines at the base of the ID and OD weld-flash, machining marks and cracks) present during the post-weld aging cycle. In an embodiment, friction welds that are post-weld aged under compression may have good mechanical properties such as (without limitation) a yield strength of at least 90% (optionally as measured in accordance with ASTM B557-06), a ultimate tensile strength of at least 90% (optionally as measured in accordance with ASTM E8 and B557-06) and an elongation of at least 5% (optionally as measured in accordance with B557-06).

Further within the scope of the present disclosure are apparatus(es) that can impart, or otherwise deliver or apply, the above-referenced localized or global compressive forces or stresses to weld region of friction welded articles. FIG. 4A illustrates an embodiment of a compression apparatus 400 suitable for applying localized compressive force or stress to a friction weld 405 joining a first hollow cylindrical metallic part 410 to a second hollow cylindrical metallic part 415 to form a welded hollow cylindrical article 420. In an embodiment, localized compressive forces are suitable for hollow cylindrical articles 420 having an overall length less than about 10 feet, alternatively less than about 7 feet, alternatively less than about 6 feet, alternatively less than about 5 feet. The first metallic part 410 may include an end 425 that is abutted against (or placed against or adjacent to) a first end plate 430. The second metallic part 415 may include one or more circumferential thrust or torque transmitting grooves 435 that may be machined into the second metallic part 415 to a depth ranging from about 75% to about 1% of the difference between the OD and the ID; alternatively ranging from about 50% to about 10% of the difference between the OD and the ID; and alternatively ranging from about 40% to about 25% of the difference between the OD and the ID. The thrust or torque transmitting grooves 435 may engage or otherwise receive a clamp 440. The end plate 430 and clamp 440 may each include at least one bore 445A, 445B that may be substantially aligned such that a linear tension rod (or “tension rod”) 450 may be received by respective bores 445A, 445B. Preferably, the end plate 430 and clamp 440 each include a plurality of bores 445A, 445B that may be substantially aligned to each receive a respective linear tension rod 450. Further, the linear tension rod 450 may be threaded at each distal end to receive a respective nut 455A, 455B. In an embodiment, rotation of the nuts 445A, 445B (or rotation of the tension rod 450 against the nuts 445A, 445B) may provide localized compression to the friction weld 405.

FIG. 4B illustrates an embodiment of a second compression apparatus 460 suitable for applying localized compressive force or stress to an alternative friction weld 465 joining a first alternative hollow cylindrical metallic part 470 to a second alternative hollow cylindrical metallic part 475 to form an alternative welded hollow cylindrical article 477. The first alternative metallic part 470 may include an alternative end 480 that is abutted against (or placed against or adjacent to) an alternative first end plate 483. The second alternative metallic part 475 may include an alternative second end 485 that is abutted against (or placed against or adjacent to) a second end plate 487. The alternative end plate 483 and the second alternative end plate 485 may each have alternative bores 490A, 490B that may be substantially aligned such that an alternative linear tension rod (or “tension rod”) 493 may be received by respective alternative bores 490A, 490B though the hollow, cylindrical first alternative metallic part 470 and the hollow, cylindrical second alternative metallic part 475. Further, the alternative linear tension rod 493 may be threaded at each distal end to receive a respective alternative nut 495A, 495B. In an embodiment, rotation of the alternative nuts 495A, 495B may provide localized compression to the alternative friction weld 465.

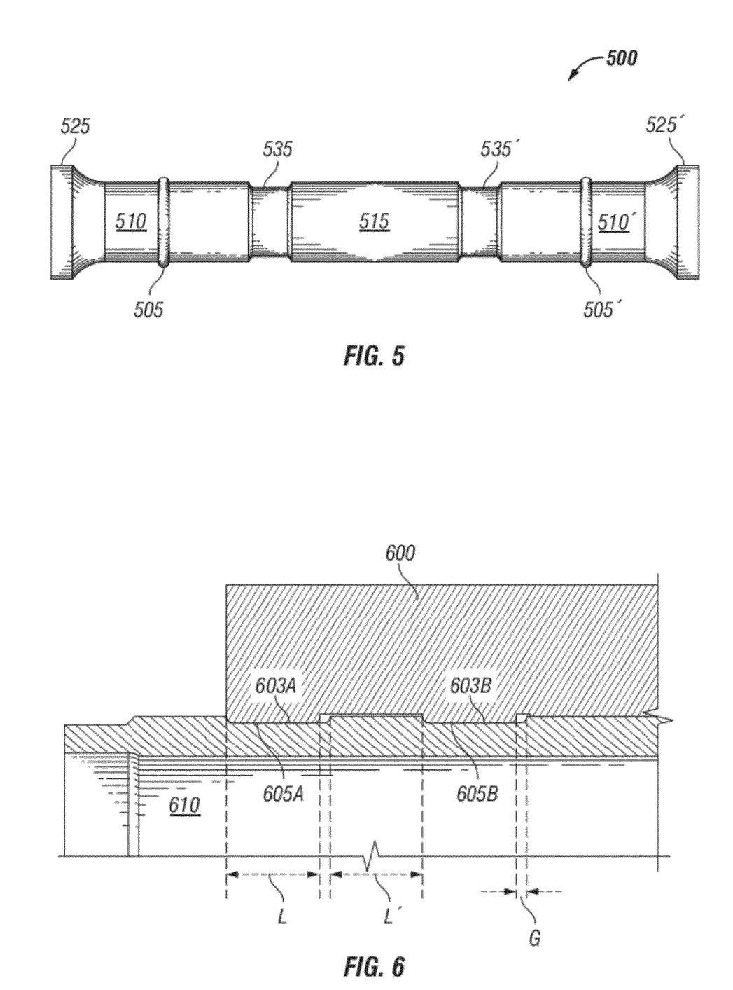

FIG. 5 is a perspective view of an embodiment of a second friction welded assembly 500. The second friction welded assembly 500 may include friction welds 505 and 505′ joining a first hollow cylindrical metallic part 510 to a second hollow cylindrical metallic part 515 to a third hollow cylindrical metallic part 510′. The first metallic part 510 and the third metallic part 510′ may each include a respective end 525, 525′ for placement or abutment against (or adjacent to) a first end plate (a suitable first end plate is shown in FIG. 4A as element 430). The second metallic part 515 may include one or more circumferential thrust or torque transmitting grooves 535 (and 535′) that may be machined into the second metallic part 515 to a depth ranging from about 75% to about 1% of the difference between the OD and the ID; alternatively ranging from about 50% to about 10% of the difference between the OD and the ID; and alternatively ranging from about 40% to about 25% of the difference between the OD and the ID.

FIG. 6 is an illustrative cross-section view of an embodiment of a dual-tongue compression clamp 600 engaged with two grooves 605A, 605B of a hollow, cylindrical metallic part 610. The grooves 605A, 605B are each, in an embodiment, 4.5 inches in horizontal length, L and L′, and each tongue 603A, 603B of the dual-tongue compression clamp 600 are, in an embodiment, 4 inches in horizontal length. In an embodiment there is a gap, G, between the tongue and groove, which may be about 0.5 inches in length.

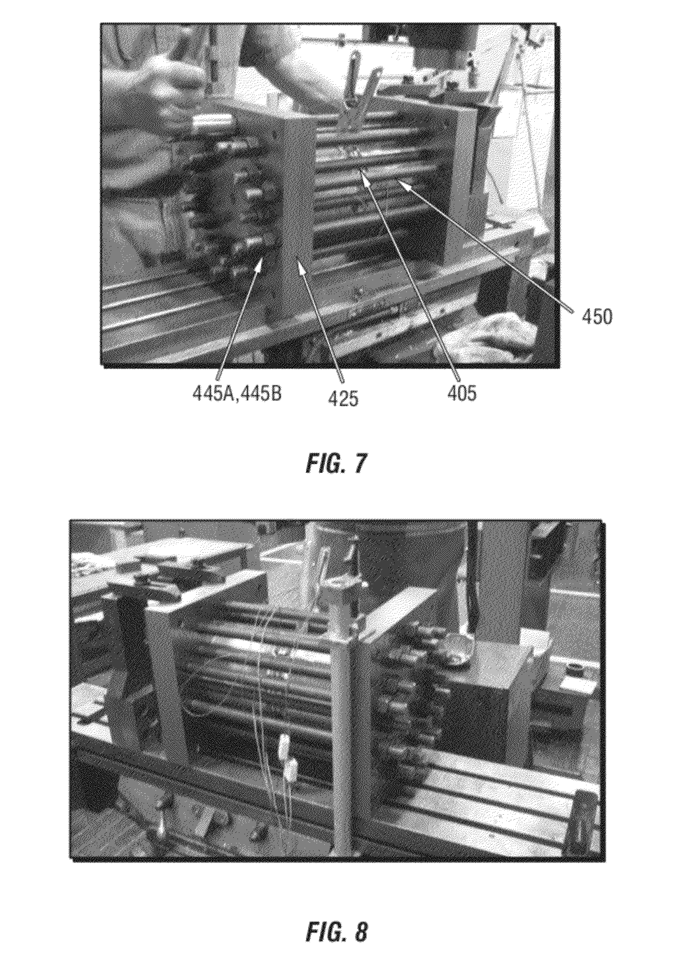

FIGS. 7 and 8 are perspective views of the friction welded assembly of FIG. 4A engaged in the compression apparatus 400 of FIG. 4A for applying a compressive load to the friction weld 405 joining a first hollow cylindrical metallic part 410 to a second hollow cylindrical metallic part 415 to form a welded hollow cylindrical article 420. The first metallic part 410 may include an end 425 that is abutted against (or placed against or adjacent to) a first end plate 430. The end plate 430 and clamp 440 each include at least one bore 445A, 445B that may be substantially aligned such that a linear tension rod (or “tension rod”) 450 may be received by respective bores 445A, 445B. The linear tension rod 450 is threaded at each distal end to receive a respective nut 455A, 455B. Rotation of the nuts 445A, 445B provides localized compression to the friction weld 405. In an embodiment wherein post-weld aging of the weld would be carried out with a localized compressive load of 30 ksi superimposed onto the friction weld prior to aging, the compressive load may be shortened by about 0.02 inches (or 0.5 millimeters) during the post-weld aging cycle by the combination of localized yielding of the weld region and creep.

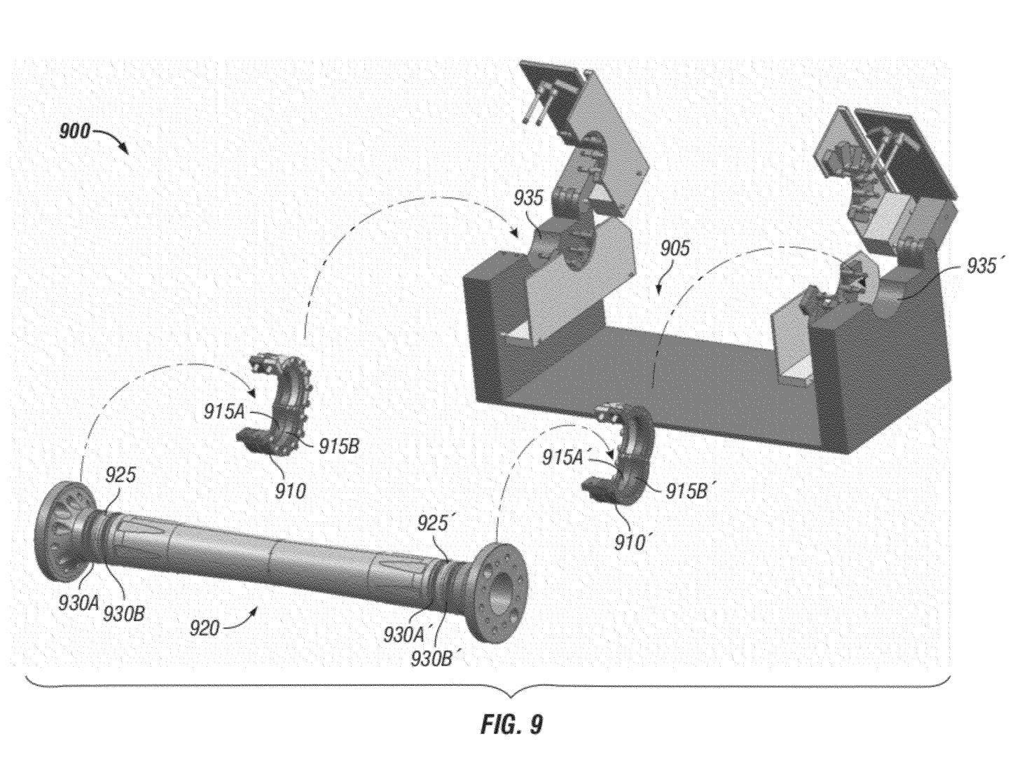

FIG. 9 is an illustrative view of a clamping installation system 900 having: a base apparatus 905; two compression pivotal C (or clam-shaped) clamps 910, 910′ each having two tongues 915A and 915B and 915A′ and 915B′; and a friction welded assembly 920 having two fiction welds 925, 925′ each between two thrust transmitting grooves 930A and 930B and 930A′ and 930B′.

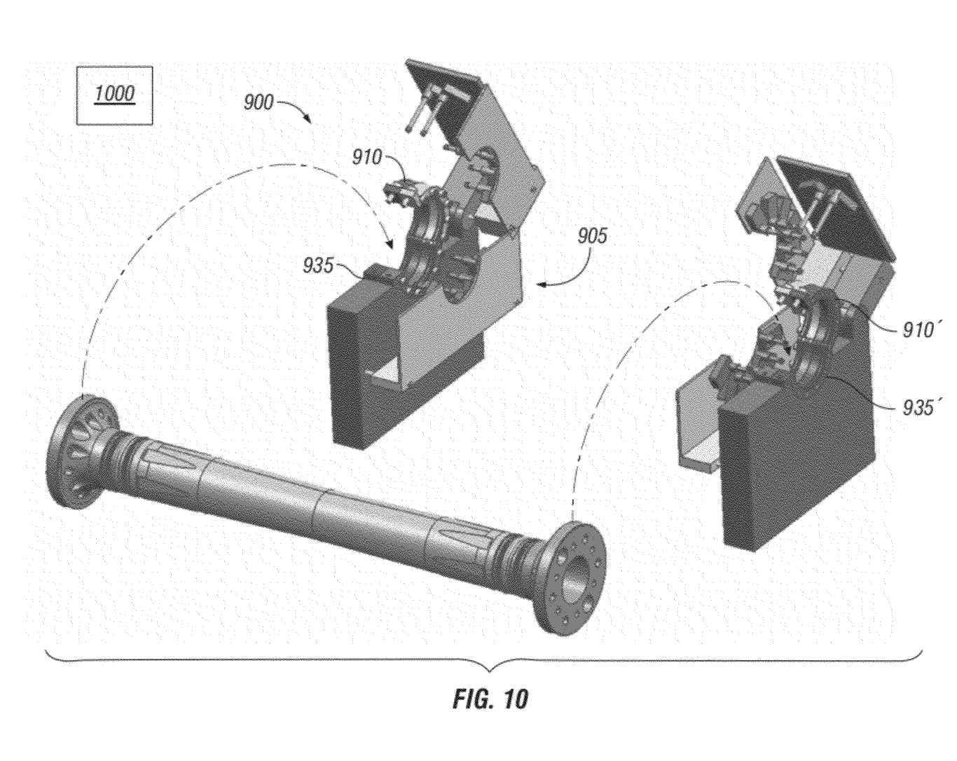

FIG. 10 is an illustrative perspective view of a first step 1000 of a clamping installation system 900 of FIG. 9. In an embodiment, the first step 1000 includes placing the compression clamps 910, 910′ within respective seats 935, 935′ of the base apparatus 905.

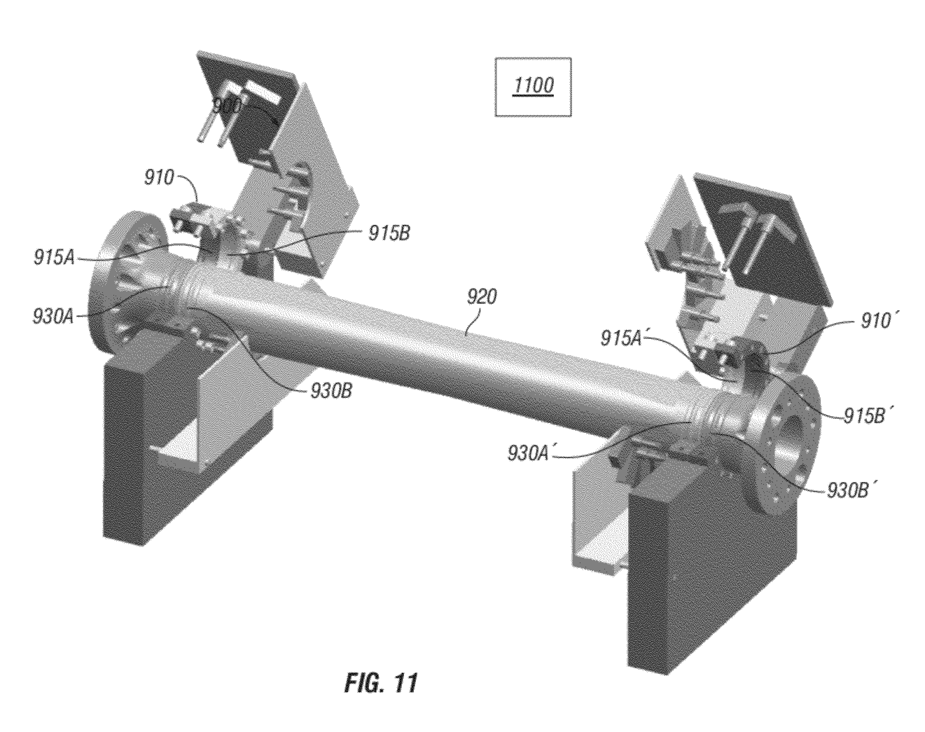

FIG. 11 is an illustrative perspective view of a second step 1100 of a clamping installation system 900 of FIG. 9. In an embodiment, the second step 1100 includes placing the friction welded assembly 920 into the compression clamps 910, 910′ such that the tongues 915A and 915B and 915A′ and 915W of the clamps 910, 910′ are aligned with the respective thrust transmitting grooves 930A and 930B and 930A′ and 930B′.

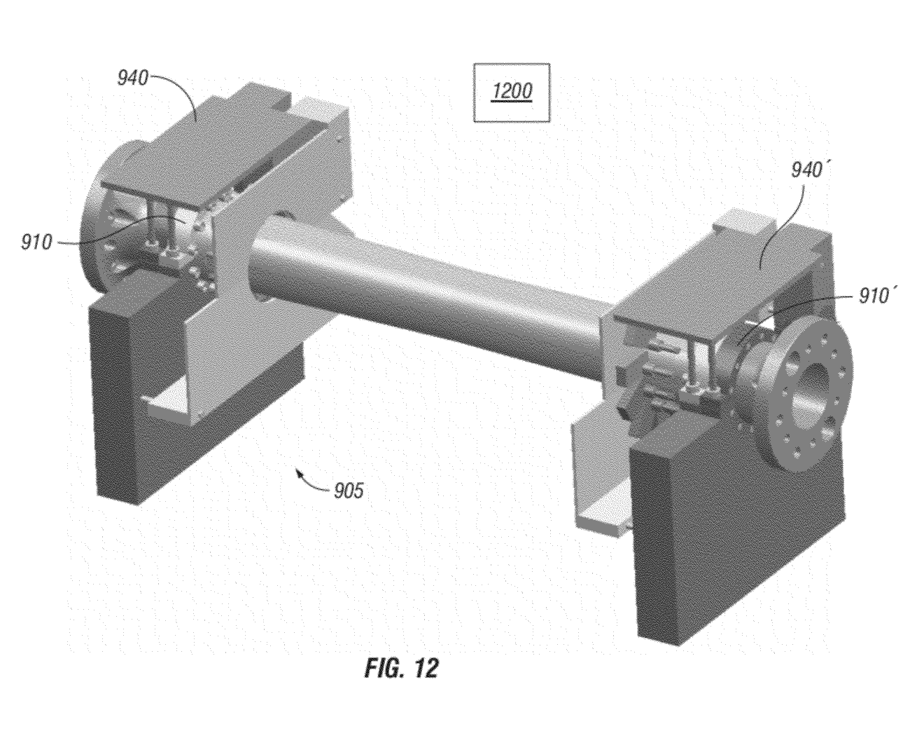

FIG. 12 is an illustrative perspective view of a third step 1200 of a clamping installation system of FIG. 9. In an embodiment, the third step 1200 includes swinging, or closing, the pivotal C compression clamps 910, 910′ such that the tongues 915A and 915B and 915A′ and 915B′ of the clamps 910, 910′ are closed about the respective thrust transmitting grooves 930A and 930B and 930A′ and 930B′. The pivotal C compression clamps 910, 910′ may be locked closed by bolts or other suitable mechanical connection. The third step 1200 further includes closing or swinging pivotal loading arms 940, 940′ of the base apparatus 905 about respective closed compression clamps 910, 910′.

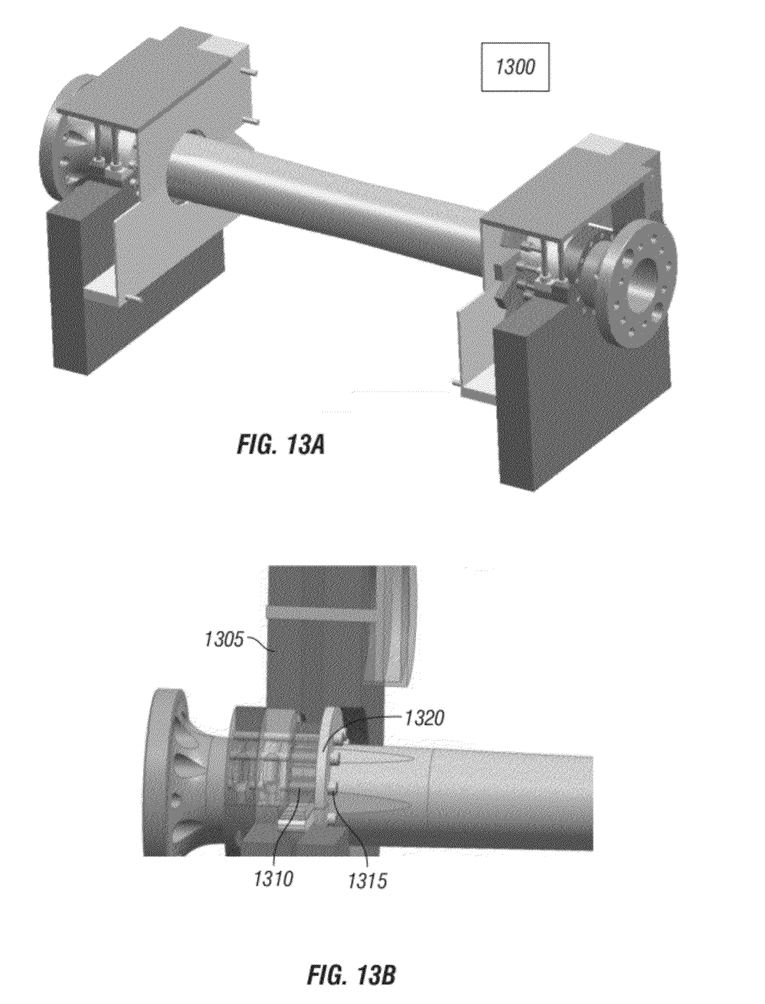

FIGS. 13A and 13B are illustrative perspective views of a fourth step 1300 of a clamping installation system of FIG. 9. In an embodiment, the fourth step 1300 includes diving an axial bolt driving head 1305 such that the tension rods 1310 are driven against the nuts 1315 and plate ends 1320 to place the welds under compression.

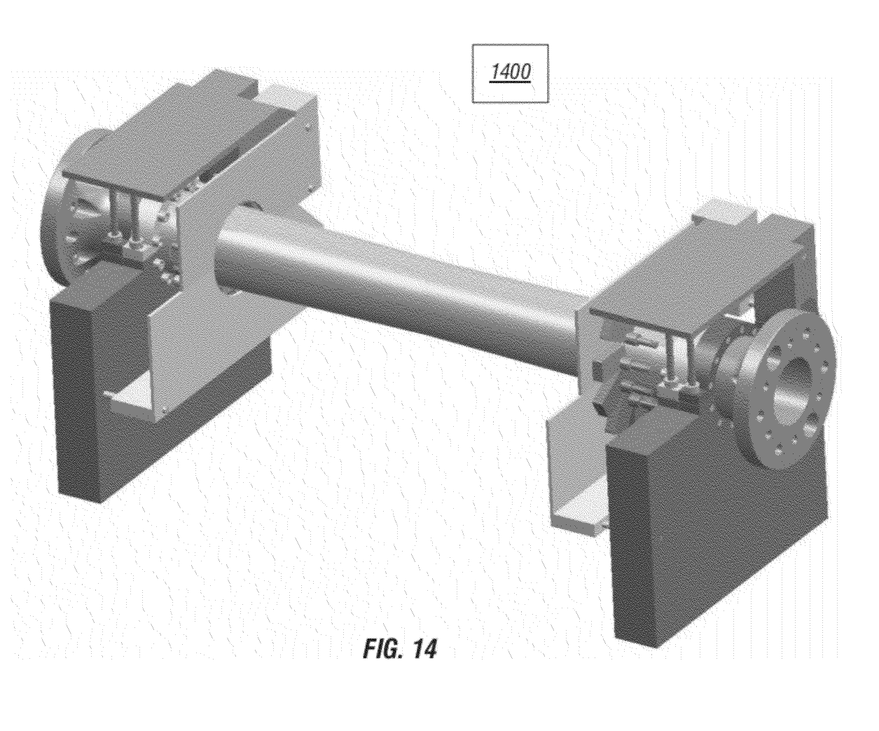

FIG. 14 is an illustrative perspective view of a fifth step 1400 of a clamping installation system of FIG. 9. In an embodiment, the fifth step 1400 includes retracting the axial bolt driving head 1305 (not visible).

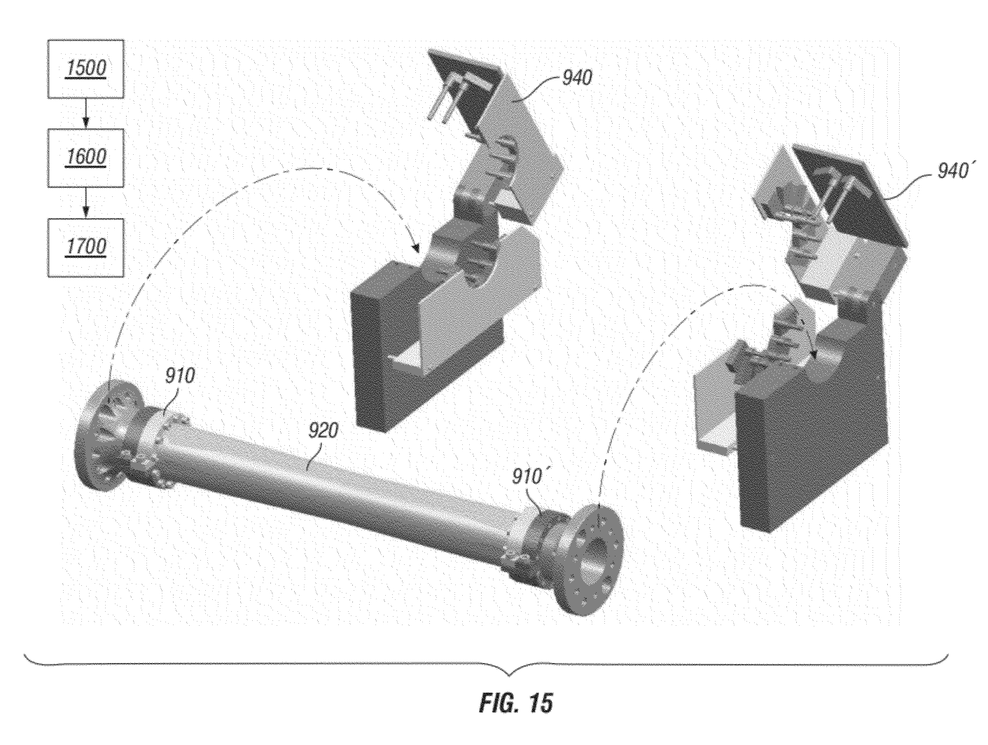

FIG. 15 is an illustrative perspective view of a sixth step 1500, a seventh step 1600, and an eighth step 1700, of a clamping installation system of FIG. 9. In an embodiment, the sixth step 1500 includes swinging open the pivotal loading arms 940, 940′. The seventh step 1600 includes removing the friction welded assembly 920 having the two compression pivotal C (or clam-shaped) clamps 910, 910′ each applying a compressive force or stress to the respective fiction welds 925, 925′ (not visible in FIG. 15) and placing the friction welded assembly 920 into a post-weld aging oven (not shown) and post-weld aging. The eighth step 1700 includes removing the friction welded assembly 920 from the post-weld aging oven.

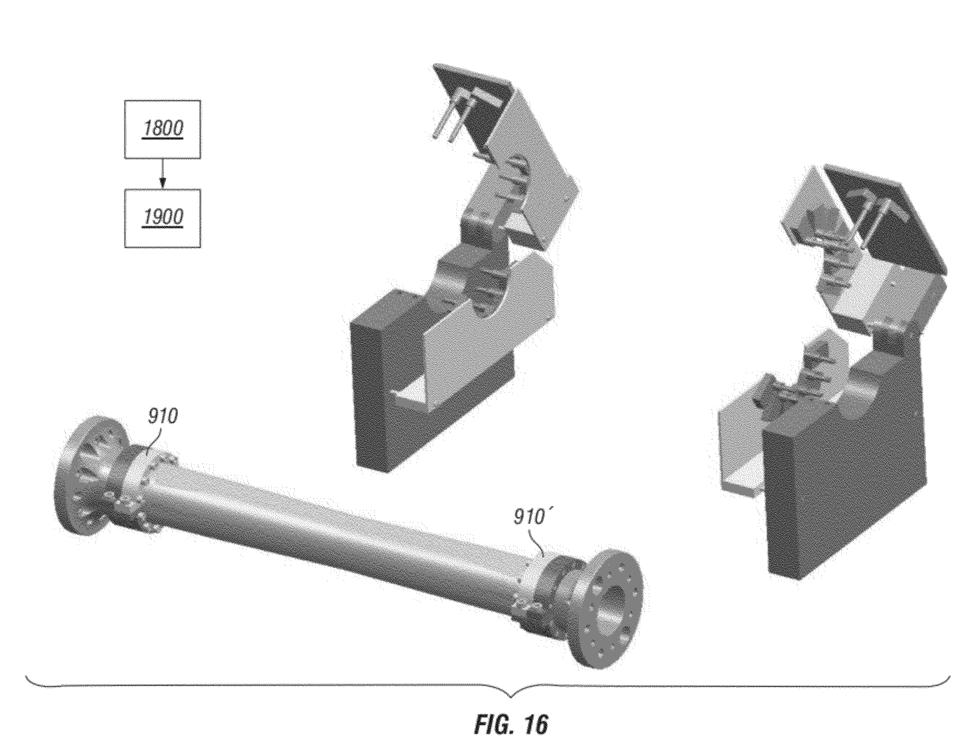

FIG. 16 is an illustrative perspective view of a ninth step 1800 and tenth step 1900 of a clamping installation system of FIG. 9. In the ninth step 1800, the force or stress applied by the compression clamps 910, 910′ is released by rotation of the axial bolt driving head 1305 (shown in FIG. 13). In the tenth step 1900, the compression clamps 910, 910′ are removed from about the friction welds 925, 925′ (not visible in FIG. 16). In an embodiment, the first step 1000 through tenth step 1900 may be performed sequentially. In an embodiment, the method of the first 1000 through tenth step 1900 is applied to a hollow, cylindrical metallic article having an overall length less than about 10 feet, alternatively less than about 9 feet, alternatively less than about 8 feet, alternatively less than about 7 feet, alternatively less than about 6 feet, alternatively less than about 5 feet, and alternatively less than about 4 feet.

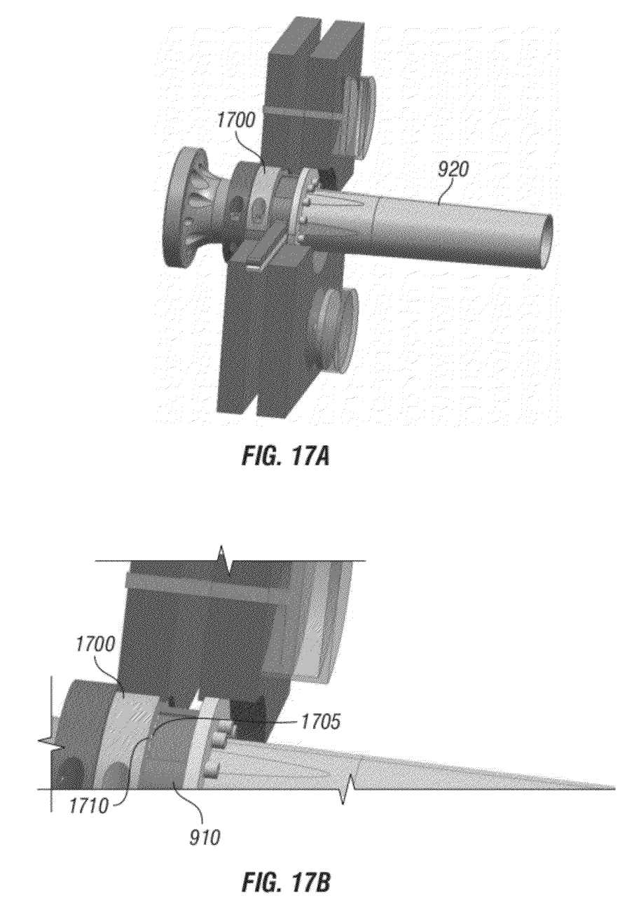

FIGS. 17A and 17B are illustrative perspective views of an optional locking ring 1700. The locking ring 1700 may include loose (not visible) slots though which the tension rods (not visible) may pass such that the ring 1700 can rotate about them when used as a locking wedge and upon release and removal of the assembly 920. In an embodiment, the locking wedge 1700 includes angled teeth 1705 (preferably at an 8 degree angle) and corresponding teeth 1710 on an end-face of the compression clamp 910. Rotation of the locking ring wedges 1700 it between the axial bolt tightening plate end and the end-face of the compression clamp 910.

FIG. 18 is an illustrative perspective view of a third alterative apparatus 1800 for post weld aging a large tubular structure 1805 having a friction weld 1810 with superimposed compression. The third alterative apparatus 1800 includes a friction welded large tubular structure 1805 having a first metallic part 1815 friction welded 1810 to a second metallic part 1820. The friction welded large tubular structure 1805 is greater than five feet in over length; alternatively greater than six feet in over length; alternatively greater than seven feet in over length; alternatively greater than eight feet in over length; alternatively greater than nine feet in over length; alternatively greater than ten feet in over length. The apparatus 1800 further includes a base 1803 slidingly affixed to a fixed rail 1807. Further affixed to the base 1803 are a plurality of upper support structures 1825 having upper rollers 1827 for engaging the tubular structure 1805 and a plurality of lower support structures 1830 having lower rollers 1833 for further engaging the tubular structure 1805. A hydraulic actuator 1835 may be in mechanical connection with an first end of the tubular structure 1805 and a fixed stop 1840 may be in mechanical connection with a second end of the tubular structure 1805. Upon actuation, the actuator 1835 may compress the tubular structure 1805 against the stop 1840 thereby placing the weld 1810 under force or stress. The entire tubular structure 1805 and at least a substantial portion of the rail 1807 may be housed within a furnace 1850. In this manner, the friction weld 1810 may be post-weld aged under compressive force or stress.

FIG. 19 is an illustrative perspective view of a fourth alterative apparatus 1900 for post weld aging a large tubular structure 1905 having a diffusive weld (not visible) with superimposed compression. The fourth alterative apparatus 1900 includes a diffusive welded large tubular structure 1905 having a first metallic part 1915 friction welded (not visible) to a second metallic part 1920. The diffusive welded large tubular structure 1905 is greater than five feet in over length; alternatively greater than six feet in over length; alternatively greater than seven feet in over length; alternatively greater than eight feet in over length; alternatively greater than nine feet in over length; alternatively greater than ten feet in over length. The fourth alterative apparatus 1900 further includes a base 1903 slidingly affixed to a fixed rail 1907. Further affixed to the base 1903 are a plurality of upper support structures 1925 having upper rollers 1927 for engaging the tubular structure 1905 and a plurality of lower support structures 1930 having lower rollers 1933 for further engaging the tubular structure 1905. A hydraulic actuator (not shown) may be in mechanical connection with an first end of the tubular structure 1905 and a fixed stop 1940 may be in mechanical connection with a second end of the tubular structure 1905. Upon actuation, the actuator (not shown) may compress the tubular structure 1905 against the stop 1940 thereby placing the weld 1910 under force or stress. The entire tubular structure 1905 and at least a substantial portion of the rail 1907 may be housed within a furnace (not shown). In this manner, the friction weld 1910 may be post-weld aged under compressive force or stress. Optional centering C clamps 1955 may be placed about the diffusive welds 1910 for added stabilization during compression.

FIGS. 20A-20F are illustrative perspective views of a fifth alterative apparatus 2000 (shown completed in FIG. 20E) for providing a compressive force or stress to a welded assembly 2005 having a friction stir weld 2010. In FIG. 20A a first half clamp 2015 may engage at least a portion of a groove 2020 of a first metal part 2025. A second half clamp may 2030 may engage at least a portion of a second groove 2035 of a second metal part 2040. In FIG. 20B a reciprocal first half clamp 2045 may engage at least a portion of the groove 2020 and the first half clamp 2015. A reciprocal second half clamp 2050 may engage at least a portion of the second groove 2035 and the second half clamp 2030. In FIG. 20C a plurality of nuts 2055A, 2055B, 2055C and bolts (2060A, 2060B, and 2060C shown in FIGS. 20A and 21B) may be used to secure the first half clamp 2015 to the reciprocal first half clamp 2045 and the second half clamp 2035 to the reciprocal second half clamp 2050. In FIG. 20D a huck gun 2065 may be used to secure the first half clamp 2015 and the second half clamp 2030 and the reciprocal first half clamp 2045 and the reciprocal second half clamp 2050; thereby providing (or imposing) a compressive force or stress on the weld 2010 (not visible in FIG. 20D). In FIG. 20E the compressive force (preferably ranging from about 10 ksi to about 50 ksi) may be held for a time (preferably ranging from about 1 hour to about 36 hours) and subjected to a temperature (preferably ranging from about 100F to about 500F); thereby weld-aging the weld under compression. In FIG. 20F the clamps may be removed and a weld-aged, under compression, assembly is provided.

While a number of embodiments of the present disclosure have been described, it is understood that these embodiments are illustrative only, and not restrictive, and that many modifications and/or alternative embodiments may become apparent to those of ordinary skill in the art. For example, any steps may be performed in any desired order (and any desired steps may be added and/or any desired steps may be deleted). Therefore, it will be understood that the to-be appended claims are intended to cover all such modifications and embodiments that come within the spirit and scope of the present disclosure.

We claim:

1. A method comprising:
welding at least a first end of a first metal part to a second end of a second metal part by a solid state process to form an article having a weld having a weld region; and
post-weld aging at least the weld region by heating at least the weld to a temperature for a time and compressing the weld.

2. The method of claim 1, wherein the first metal part is an aluminum alloy selected from the group consisting of a 1xxx series, 2xxx series, 3xxx series, 4xxx series, 5xxx series, 6xxx series, 7xxx, and 8xxx series aluminum alloys, and the second metal part is a metal selected from the group consisting of a 1xxx series, 2xxx series, 3xxx series, 4xxx series, 5xxx series, 6xxx series, 7xxx, and 8xxx series aluminum alloys, wherein the first and second are a different or the same alloy.

3. The method of claim 1, wherein the first metal part and the second metal part is each independently selected from the group consisting of: titanium, titanium alloys, steel, stainless steel, copper, copper alloys, zinc, and zinc alloys, wherein the first metal part has the same or different composition as the second metal part.

4. The method of claim 1, wherein the solid state process is selected from the group consisting of friction welding, friction stir welding, diffusion bonding, cold welding, and explosion welding.

5. The method of claim 1, wherein the weld region is heated to a temperature ranging between about 200F to about 350F for a time ranging between about 2 hours to about 24 hours.

6. The method of claim 5, wherein the weld region is heated to a temperature ranging between about 300F to about 325F for a time ranging between about 6 hours to about 18 hours.

7. The method of claim 5, wherein the weld region is compressed the entire time the weld region is heated.

8. The method of claim 1, wherein the weld region is compressed to a compressive stress at least equal to the compressive yield strength of the weld region, in the as-welded condition.

9. The method of claim 8, wherein the compression is localized to the weld region and wherein the article has an overall length of less than about 10 feet.

10. The method of claim 1, wherein the weld region is compressed to a compressive stress at least about 10 ksi.

11. The method of claim 9, wherein the weld region is compressed to compressive stress between about 20 ksi and about 40 ksi.

12. The method of claim 1, wherein the weld region has a residual stress on an inner diameter and the weld region is compressed to a compressive stress sufficient to reduce the residual stress on the inner diameter by at least about 5 ksi.

13. The method of claim 1, wherein the welding produces a weld-flash on an inner and outer diameter of the first aluminum alloy part and the second metal part, and the method further comprises: machining off the weld-flash from the inner and outer diameter of the first aluminum alloy part and the second metal part.

14. The method of claim 12, wherein the welding further produces a plurality of ravines at the base of the flash weld, and wherein at least a majority of the ravines are removed when the weld-flash is machined off.

15. The method of claim 1, wherein the first metal part and the second metal part are each tubes having an outer diameter ranging from between about 1 inch to about 30 inches.

16. The method of claim 15, wherein a distance between the outer diameter and an inner diameter of the respective first metal part and the second metal part is between about 0.25 inches to about five inches.

17. An apparatus comprising:
an assembly having a first metal part and a second metal part,
wherein the first metal part includes a first end and a second end,
wherein the second metal part includes a third end and a fourth end,
wherein the second end and the third end are associated together by a friction weld, and
wherein the second metal part has at least one torque transmitting groove between the third and the fourth end; and
at least one clamp having at least a first clamp bore for receiving at least a first tension rod end of at least one tension rod, the at least one clamp having a tongue associated with the at least one torque transmitting groove,
wherein association of the tension rod, the tongue of the clamp, and the groove of the second metal part provides at least a 10 ksi compressive force on the friction weld.

18. The apparatus of claim 17, further comprising: an end plate having at least a first end plate bore for receiving at least a second tension rod end of at least the one tension rod, the end plate associated with the first end of the first metal part.

19. The apparatus of claim 17, wherein association of the tension rod, the tongue of the clamp, and the groove of the second metal part provides between about a 20 ksi to about a 50 ksi compressive force on the friction weld.

20. The apparatus of claim 19, wherein the first metal part and the second metal part are aluminum alloy, hollow, cylindrical parts.
